(19) United States
(12) Patent Application Publication
(10) Pub. No.: US 2006/0053957 A1
(43) Pub. Date: Mar. 16, 2006

(54) Electronic pedal assembly and method

(76) Inventors: David E. Ewel, Mankato, MN (US); Craig L. Lapoint, North Mankato, MN (US)

Correspondence Address: Merchant & Gould P.C., P.O. Box 2903, Minneapolis, MN, 55402-0903, US

(21) Appl. No.: 10/887,462

(22) Filed: Jul. 8, 2004

(51) Int. Cl. G05G 1/14

(52) U.S. Cl. 74/560

(57) ABSTRACT

An electronic pedal assembly including a pedal and a base. The pedal is pivotally mounted to the base by a mounting arrangement. The assembly includes a spring arrangement. The spring arrangement is retained by a number of spring retaining constructions, including arms formed on the pedal and a retaining pin. The pedal rotates relative to the base. Rotation is at least partially limited by a tab form on a bearing structure of the pedal. The base of the electronic pedal assembly includes an integral sensor housing configured to receive a sensor. Assembly is accomplished by inserting the bearing structure of the pedal within a receiving hub formed in the sensor housing of the base.

### TECHNICAL FIELD

This disclosure relates to an electronic pedal assembly. In particular, this disclosure relates to an electronic pedal assembly having a spring arrangement and sensor, and associated methods of manufacture and assembly.

### BACKGROUND

A wide variety of pedal assemblies include sensor that translate a pedal position into an electrical signal. In some conventional arrangements, the sensor is attached to the pedal such that access to the sensor for maintenance or repair is difficult. In other arrangements, the sensor is retrofit to the pedal assembly, but is often positioned off-center of the pedal pivot axis requiring a complex and costly linkage between the sensor and the pedal.

In another aspect, conventional arrangements often have spring arrangements that make assembly of the arrangement difficult. For example, a typical spring installation procedure includes maintaining the spring arrangement in a spring-loaded or biased position while simultaneously assembling other components of the pedal assembly in relation to one another.

In general, improvement has been sought with respect to such assemblies and associated methods, generally to better accommodate: manufacture and assembly, and ease of maintenance, repair, and component replacement.

### SUMMARY

One aspect of the present disclosure relates to a pedal assembly including a base, a pedal and at least one spring. The base includes a platform and an integral sensor housing, the sensor housing defining a receiving hub having a slot. The slot has first and second ends. The base further includes a recess formed in the platform. The pedal is pivotally mounted to the base. The pedal includes a pedal surface extending between first and second flanges, at least one of the first and second flanges including a bearing structure projecting outward from the flange. The bearing structure is positionable within the receiving hub and includes a tab. The tab is arranged to contact the ends of the slot of the receiving hub to limit rotation of the pedal relative to the base. The spring has an outer diameter and is at least partially located in the recess formed in the platform. The spring is retained in position relative to the base and pedal by a retaining construction arranged to extend about the outer diameter of the torsion spring.

Another aspect of the present disclosure relates to a pedal assembly having a base and a pedal. The base includes a platform and a receiving hub having a slot. The pedal is pivotally mounted to the base and includes a bearing structure positioned within the receiving hub. The bearing structure of the pedal has a cylindrical bearing surface and a tab projecting radially from the cylindrical bearing surface. The tab is positioned within the slot of the receiving hub. The assembly also includes at least one spring arranged to bias the pedal to a first angular position relative to the base.

Still another aspect of the present disclosure relates to a pedal assembly including a base and a pedal. The pedal is pivotally mounted to the base by a mounting arrangement. The mounting arrangement includes first and second lobes located a distance from one another, one of the lobes being connected to the base and the other of the lobes being connected to the pedal. The assembly also includes a spring arrangement arranged to bias the pedal to a first angular position relative to the base. The spring arrangement is positioned between the first and second lobes of the mounting arrangement. The spring arrangement has a width that substantially corresponds to the distance between the first and second lobes to axially maintain the pedal in relation to the base.

Yet another aspect of the present disclosure relates to a pedal assembly including a pedal pivotally mounted to a base. The assembly includes a spring arranged to bias the pedal to a first angular position relative to the base. A first spring retaining construction is provided to retain the spring in relation to the pedal and base. The first spring retaining construction includes arms extending from a bottom surface of the pedal. The arms include curved surfaces that extend about an outer diameter of the spring.

Another aspect of the present disclosure relates to a method of assembling a pedal device. The method includes partially assembling a pedal to a base by axially sliding a bearing structure of the pedal within a receiving hub of the base in a first direction. The method also includes rotating the pedal relative to the base to preload the spring, and fully assembling the pedal to the base by further axially sliding the bearing structure within the receiving hub in the first direction.

Still another aspect of the present disclosure relates to a method of manufacturing a base for use with an electronic pedal assembly. The method includes providing a base having an integral sensor housing, and providing a divider structure. The divider structure includes a number of slots located on a first edge. The method further includes placing electronic components within an interior region of the housing, and selectively orienting the divider structure within the interior region of the housing. The divider can be selectively oriented, for example, in one of a first orientation to provide a first number of wire exits for the electronic components; and a second orientation to provide a second different number of wire exits for the electronic components.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a front perspective view of one embodiment of an electronic pedal assembly having a base and a pedal, according to the principles of the present disclosure;

FIG. 2 is a front perspective view of the electronic pedal assembly of FIG. 1, shown partially assembled;

FIG. 3 is a side elevation view of the electronic pedal assembly of FIG. 1;

FIG. 4 is a rear elevation, partial cross-sectional view of the electronic pedal assembly of FIG. 3, taken along line 4-4;

FIG. 5 is a front perspective view of another embodiment of a base of the electronic pedal assembly;

FIG. 6 is another front perspective view of the base of FIG. 5;

FIG. 7 is a partial, bottom plan view of the base of FIG. 5;

FIG. 8 is a top plan view of a wire-retaining piece used in the pedal assembly of FIG. 1;

FIG. 9 is a bottom plan view of the wire-retaining piece of FIG. 8 shown in a first orientation relative to the base of FIG. 7;

FIG. 10 is a perspective view of the wire-retaining piece of FIG. 8 shown in a second orientation relative to the base of FIG. 7;

FIG. 11 is a side elevation view of one embodiment of a torsion spring shown in the electronic pedal assembly of FIG. 1;

FIG. 12 is a front elevation view of the torsion spring of FIG. 11;

FIG. 13 is a perspective view of one embodiment of a retaining pin shown in the electronic pedal assembly of FIG. 1;

FIG. 14 is a rear elevation, partial cross-section view of the electronic pedal assembly, shown with an alternative retaining pin embodiment;

FIG. 15 is a front perspective view of the electronic pedal assembly of FIG. 1, shown with the retaining pin partially inserted;

FIG. 16 is a front perspective view of the electronic pedal assembly of FIG. 15, shown with the pedal rotated during an assembly step (and shown with yet another alternative embodiment of a retaining pin partially inserted);

FIG. 17 is a front perspective view of the electronic pedal assembly of FIG. 16, shown completely assembled;

FIG. 18 is a bottom perspective view of an alternative embodiment of a pedal of the electronic pedal assembly; and

FIG. 19 is an exploded, front perspective view of another embodiment of an electronic pedal assembly according to the principles of the present disclosure, shown with the pedal of FIG. 18 and still another embodiment of a base.

### DETAILED DESCRIPTION

Reference will now be made in detail to various features of the present disclosure that are illustrated in the accompanying drawings. Wherever possible, the same reference numbers will be used throughout the drawings to refer to the same or like parts.

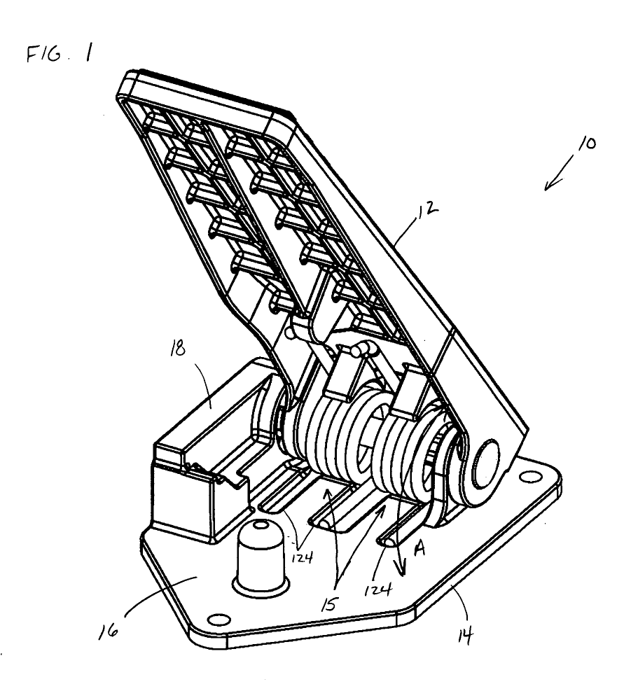

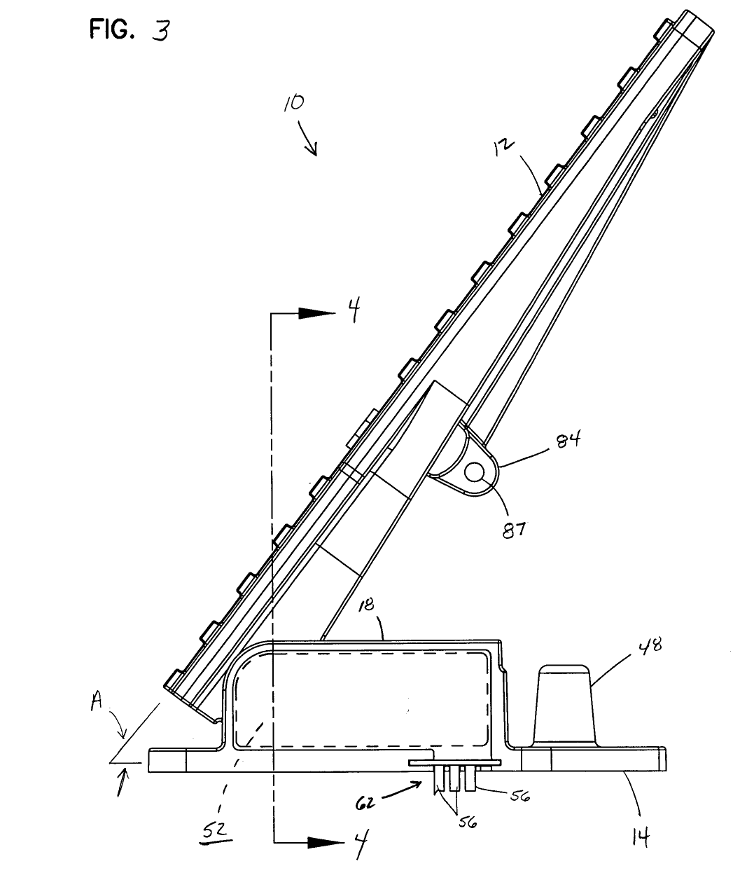

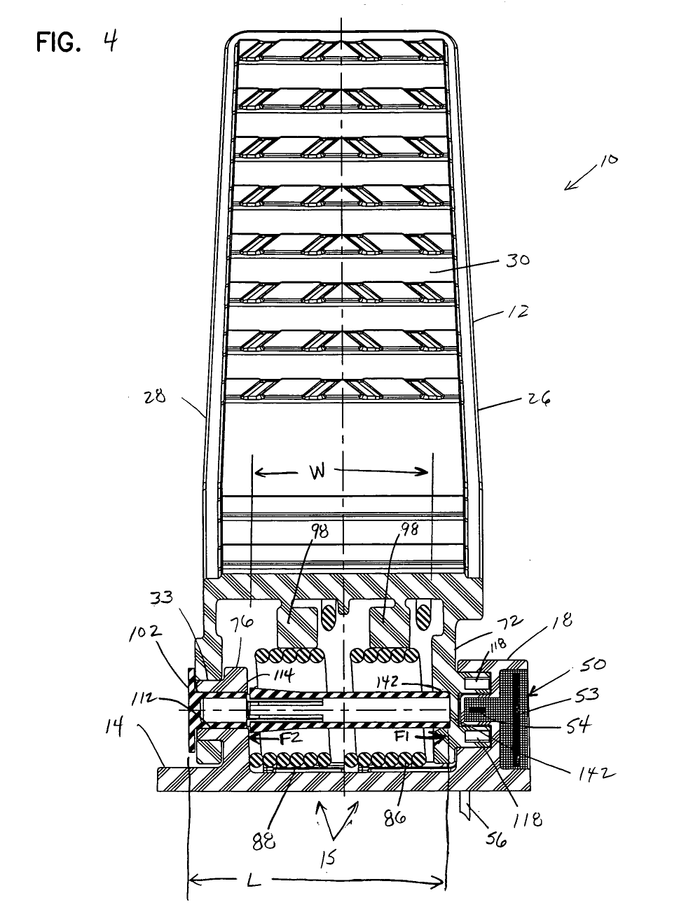

FIG. 1 illustrates an electronic pedal assembly 10 having features that are examples of how inventive aspects in accordance with the principles of the present disclosure may be practiced. In general, the electronic pedal assembly 10 includes a pedal 12 that rotates in relation to a base 14. A spring arrangement 15 is provided to bias the pedal to a first angular position (represented by angle A in FIGS. 1 and 3) relative to the base 14. The base 14 of the illustrated pedal assembly 10 includes a platform 16 and a housing structure 18 formed as an integral construction of the base 14. The housing structure 18 is sized and configured to receive a sensor 50 (FIG. 4). The integral construction of the housing structure 18 and the platform 16 reduces the overall size of the arrangement, and reduces assembly costs associated with attaching a separate housing structure.

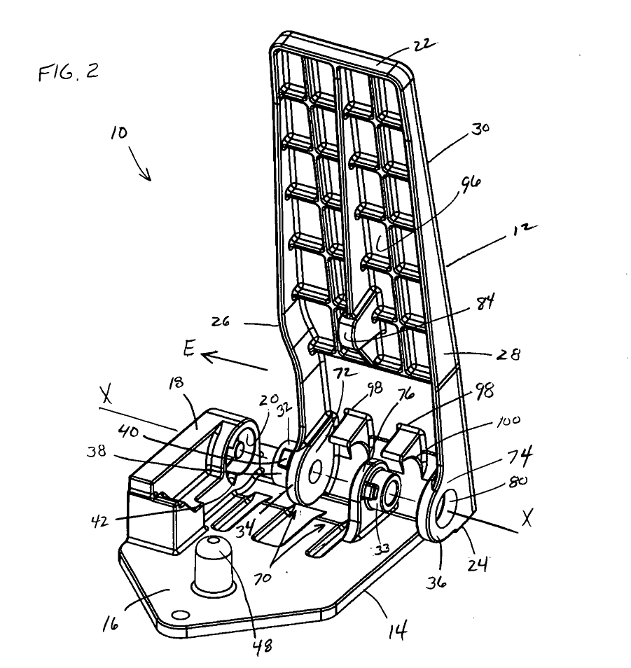

Referring now to FIG. 2, the pedal 12 is shown un-assembled from the base 14 of the pedal assembly 10. The pedal 12 of the electronic pedal assembly 10 has a first end 22, a second end 24, and a first side 26 opposite a second side 28. A pedal surface 30 (FIG. 4) extends between the first and second sides 26, 28 of the pedal 12. The second end 24 of the pedal 12 is connected to the base 14 such that the pedal 12 pivots about an axis of rotation X-X. A first bearing structure 32 is located on the first side 26 of the pedal 12 adjacent to the second end 24 of the pedal. In the illustrated embodiment, the first bearing structure 32 extends outward from a first flange portion 34 defined by the first side 26 of the pedal.

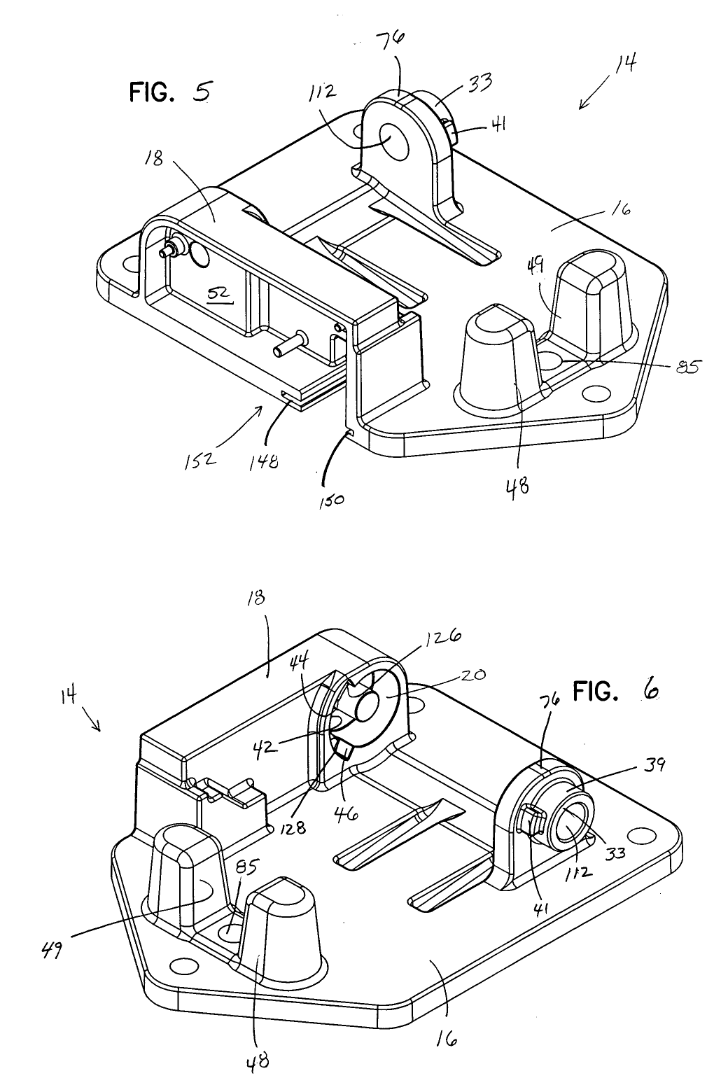

The first bearing structure 32 is sized and configured for receipt within a receiving hub 20 of the base 14. In the illustrated embodiment, the receiving hub 20 is formed in the integral sensor housing 18 of the base 14. The first bearing structure 32 includes a cylindrical bearing surface 38 and a first tab 40 that projects radially from the cylindrical bearing surface 38. When the bearing structure 32 is positioned within the receiving hub 20 of the base 14, the tab 40 is positionable within an arcuate slot 42 (FIG. 6) formed in the receiving hub 20. In use, the tab 40 moves within the slot 42 as the pedal 12 rotates about the axis of rotation X-X. The angle of rotation of the pedal 12 is limited between a first stop or end 44 (FIG. 6) of the slot 42 and a base stop 48 (FIGS. 2 and 3) formed on the platform 16 of the base 14. The first end 44 of the slot 42 sets the first angular position A of the pedal. That is, the first end 44 of the slot 42 limits the pedal 12 from being biased by the spring arrangement 15 beyond the first angular position A.

The base stop 48 is the primary stop that limits rotation beyond a maximum angular position relative to the first angular position A. In the embodiment of FIG. 2, the base stop 48 contacts a central boss 84 formed on a bottom surface 96 of the pedal 12 (FIG. 2) to prevent the pedal from being over-rotated. As an added safety feature, the arcuate slot 42 has a second stop or end 46 (FIG. 6) that would also limit rotation of the pedal 12 in the event the base stop 48 were to fail. In such an event, the tab 40 would contact the second end 46 of the slot 42 to limit further rotation of the pedal 12.

In another embodiment, as shown in FIG. 5, the base stop 48 is sized and construction to include a channel 49. The channel 49 can be used to accommodate a throttle cable (not shown) coupled to the pedal. For example, a throttle cable can be positioned through a through-hole 85 formed in the platform 16 and coupled to a hole 87 (FIG. 3) formed in the central boss 84 of the pedal 12. In such an application, the throttle cable is used to hold the pedal in a desired angular position during operation.

Referring back to FIG. 2, the pedal assembly 10 also includes a second bearing structure 33. The second bearing structure 33 is sized and configured for receipt within an aperture 80 formed in the second side 28 of the pedal 12. Referring now to FIG. 6, the second bearing structure 33 also includes a cylindrical bearing surface 39. A second tab 41 projects radially from the cylindrical bearing surface 39. When the second bearing structure 33 is positioned within the aperture 80 of the pedal 12, the tab 41 is positionable within a slot (not shown) formed in the side 28 of the pedal 12. The slot corresponding to the second tab 41 may also include ends configured to limit the angular rotation of the pedal 12 relative to the base 14.

Referring now to FIGS. 3 and 4, the sensor 50 of the pedal assembly 10 is arranged to sense the angular position of the pedal 12 relative to the base 14. The sensor 50 is located within an interior region 52 (see also FIG. 5) of the integral housing structure 18. In one embodiment, the sensor 50 may include a self-calibrating sensor that uses microprocessor technology to calibrate the output of the sensor in relation to predetermined values. This sensor can be used in combination with an algorithm to continually calibrate the sensor's output and compensate for any component wear. In the illustrated embodiment, the sensor 50 includes a hall-effect sensor 54, a DC to DC converter (not shown), magnets 118, and other components such as a switch (not shown) and wire leads 56. The hall-effect sensor 54 operates in conjunction with the magnets 118, which may be embedded within the first bearing structure 32 of the pedal 12, for example. A printed circuit board 53 is also provided to interconnect the electrical components and hall effect sensor.

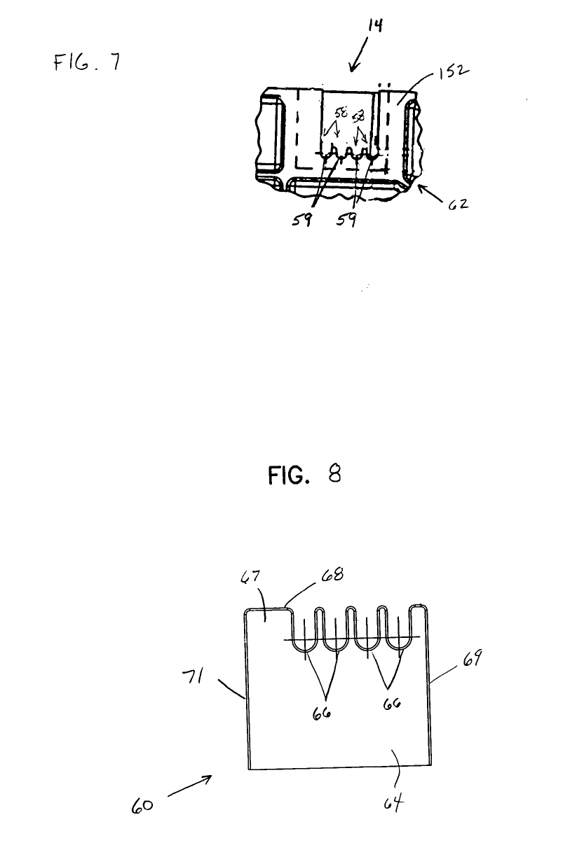

Referring now to FIGS. 7 and 8, the base 14 of the present disclosure has a wire exit configuration 62; that is, the base 14 is configured to accommodate the exit of the wire leads 56 of the sensor 50. In particular, the wire leads 56 extend through wire exits 58 formed between slots 66 of a bottom wire-retaining piece 60 (FIG. 8) and slots 59 of the base 14. The exits 58 extend into the interior region 52 of the housing structure 18 of the base so that the wire leads 56 exit the base 14 at a bottom 152 of the base.

The wire-retaining piece 60 shown in FIG. 8 includes a main portion 64 having a first edge 68. The slots 66 of the wire-retaining piece 60 are formed along the first edge 68. The first edge 68 also defines a non-slotted section 67. Side edges 69, 71 of the wire-retaining piece 60 are positionable within first and second grooves 148, 150 (FIG. 5) formed in the platform 16 of the base 14. In particular, the wire-retaining piece 60 slides into the grooves 148, 150 of the platform 16 and captures the wire leads 56 of the sensor 50 within the exits 58.

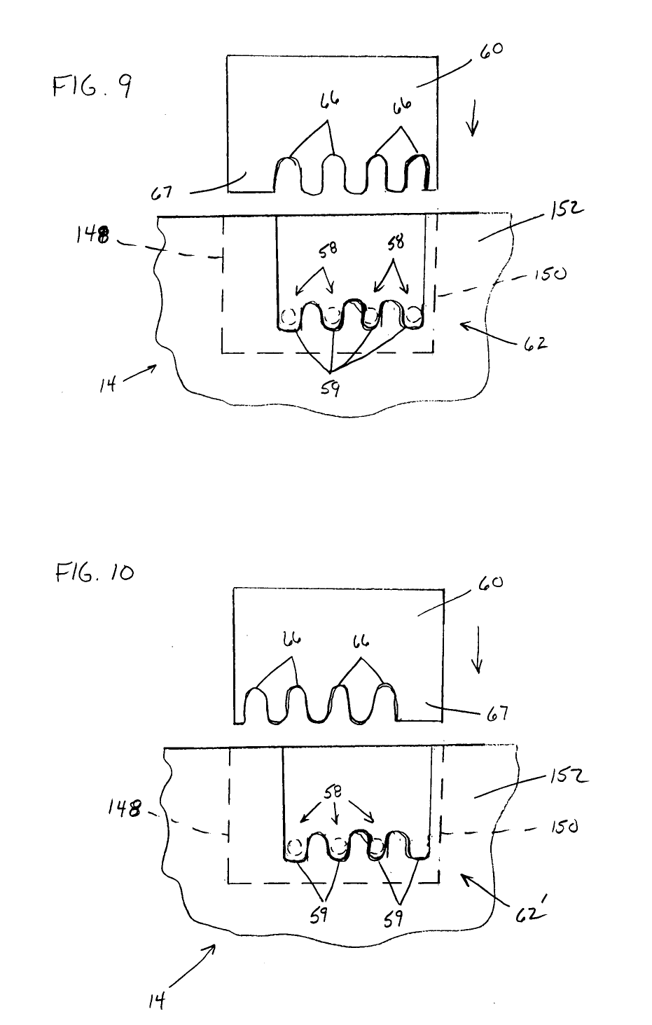

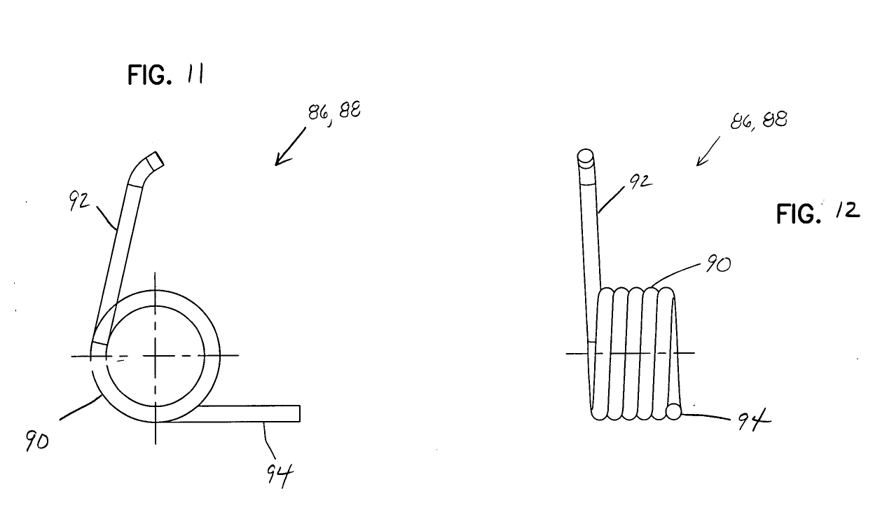

Referring now to FIGS. 9 and 10, the wire-retaining piece 60 is configured to provide a plurality of different wire exit configurations when positioned with the first and second grooves 148, 150 of the base. For instance, a first wire exit configuration 62 is produced when the wire-retaining piece 60 is oriented in a first orientation, as shown in FIG. 9. In the first orientation, the non-slotted section 67 of the wire-retaining piece 60 is inserted into the first groove 148 (see also FIG. 5) of the base 14. When positioned in the first orientation, four wire exits 58 are provided at the bottom 152 of the base 14. The four wire exits 58 (also represented by dashed circles) are formed when the slots 66 of the wire-retaining piece 60 align with the slots 59 of the base 14.

A second wire-exit configuration 62′ is produced when the wire-retaining piece 60 is oriented in a second orientation, as shown in FIG. 10. In the second orientation, the wire-retaining piece 60 is flipped so that the non-slotted section 67 of the wire-retaining piece 60 is inserted into the second groove 150 (see also FIG. 5) of the base 14. When positioned in the second orientation, three wire exits 58 are provided at the bottom 152 of the base. The number of exits 58 is determined by one or more of the slots 66 in the wire-retaining piece being mis-aligned from the slots 59 of the base, and/or the non-slotted section 67 of the wire-retaining piece 60 covering one or more of the slots 59 formed in the base 14. The wire-retainer piece 60 is arranged to provide different wire exit configurations to accommodate a number of different sensor types. It is contemplated that wire exit configurations having other numbers of wire exits can be made in accord with the principles disclosed.

Referring back to FIG. 2, the pedal assembly 10 generally includes a mounting arrangement 70 that pivotally mounts or connects the pedal 12 to the base 14. The mounting arrangement 70 includes a first mounting element or pedal lobe 72 connected to the pedal 12, a second mounting element or pedal lobe 74 connected to the pedal, and a third mounting element or base lobe 76 connected to the base 14. In general, the first pedal lobe 72 is defined by the first flange portion 34 of the pedal, and the second pedal lobe 74 is defined by a second flange portion 36 of the pedal opposite the first flange portion 34.

The first lobe 72 of the mounting arrangement 70 includes the first bearing structure 32, which is received within the receiving hub 20 of the base 14. The second lobe 74 of the mounting arrangement 70 interconnects to the third lobe 76 of the base 14. In particular, the third base lobe 76 includes the second bearing structure 33, which is received within the aperture 80 formed in the second pedal lobe 74. In the illustrated embodiment, the first and second bearing structures 32, 33 of the pedal assembly 10 generally define the axis of rotation X-X. The first bearing structure 32 is formed as an integral part of the pedal 12 and the second bearing structure 33 is formed as an integral part of the base 14.

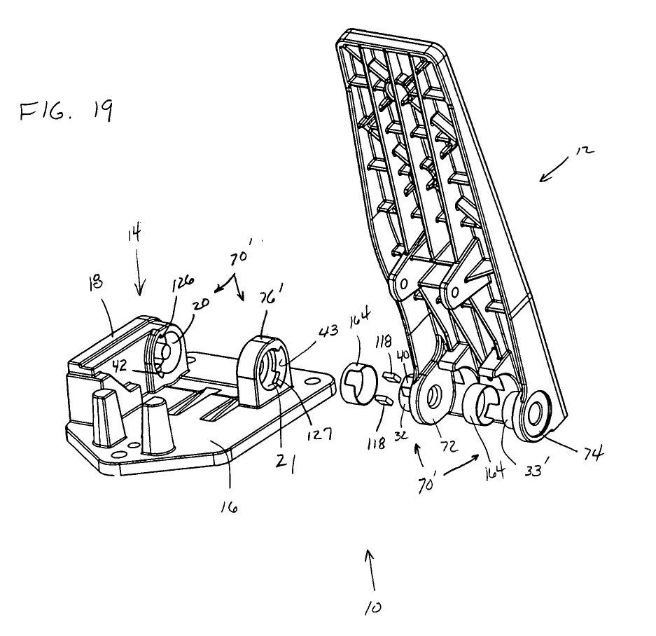

In an alternative embodiment, other pivoting connections can be used, including, for example, axle structures or an arrangement wherein the connections of the lobes 76, 74 are reversed. For example, referring to FIGS. 18 and 19, another embodiment of a mounting arrangement 70′ is illustrated. In this embodiment, the pedal 12 includes both the first and second bearing structures 32, 33′ and the third lobe 76 of the base 14 includes a second receiving hub 21.

Referring to FIG. 18, the first lobe 72 of the alternative mounting arrangement 70′ includes the first bearing structure 32, which is received within the receiving hub 20 of the base 14. The second lobe 74 of the mounting arrangement 70′ includes the second bearing structure 33′, which is received within the second receiving hub 21. Both the first bearing structure 32 and the second bearing structure 33′ are formed as an integral part of the pedal 12. In addition, the alternative mounting arrangement 70′ can include journal bearings 164 (FIG. 19) to aid in providing less friction between the pedal 12 and the base 14. Each of the journal bearings 164 is slotted to accommodate the tabs 40 (only one shown) of the bearing structures 32, 33′. It is to be understood that the pedal and base incorporating the alternative mounting arrangement 70′ illustrated in FIGS. 18 and 19 function in the same manner as the first embodiment. The remainder of the detailed description refers to the first embodiment, however, is applicable to the alternative embodiment of FIGS. 18 and 19.

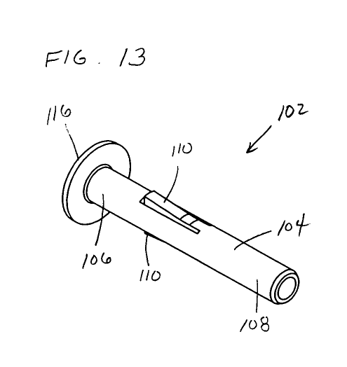

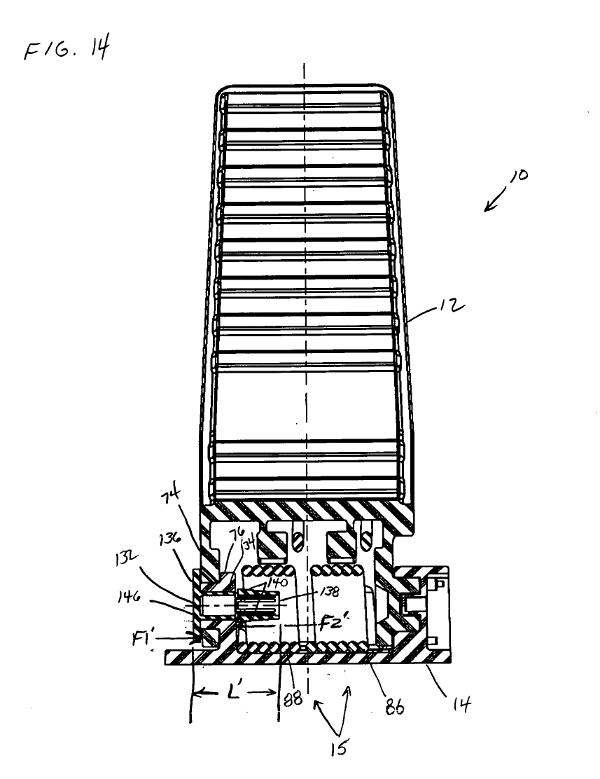

Referring back to the embodiment of FIG. 4, the mounting arrangement 70 is also configured to at least partially retain the spring arrangement 15 of the pedal assembly 10. In the illustrated embodiment, the spring arrangement 15 includes first and second springs 86, 88. The first and second springs in this embodiment are torque or torsion springs. As shown in FIGS. 11 and 12, each of the torsion springs 86, 88 of the spring arrangement 15 includes a spring coil 90 and upper and lower tangs 92, 94 extending outward from the spring coil 90. While referred to as upper and lower tangs, it will be appreciated that the tangs of the illustrated embodiment of the present disclosure need not be limited to upper or lower. Rather, the terms “upper and lower” are used for explanatory purposes of the illustrated embodiment. Tangs configured at various positions relative to one another other than upper and lower, such a forward and rearward, for example, are within the scope of the present disclosure.

Referring again to FIG. 4, the spring arrangement 15 is positioned between the first pedal lobe 72 and the third base lobe 76 of the mounting arrangement 70. In essence, the lobes 72, 76 of the mounting arrangement generally define a spring retaining construction. Yet, the spring arrangement 15 is sized to also axially retain the pedal 12 in relation to the base 14. In particular, the spring arrangement 15 has a width W that substantially corresponds to a distance between the first and third lobes 72, 76 of the mounting arrangement 70 to axially maintain the relative positions of the pedal 12 and the base 14. That is, the width W of the spring arrangement 15 is configured to minimize axial movement of the pedal 12, i.e. movement along the rotational axis X-X, when the spring arrangement 15 is positioned between the lobes of the mounting arrangement 70. This design prevents unwanted movement or play between various components that may accelerate wear and cause component failure.

The pedal assembly 10 also includes other spring retaining constructions designed to retain the spring arrangement 15 in relation to the pedal 12 and the base 14. For example, referring to FIGS. 2 and 4, another spring retaining construction includes arms 98 located adjacent to the second end 24 of the pedal 12. Each of the arms 98 includes a curved surface 100 (FIG. 2) that extends or wraps about an outer diameter of the spring coil 90 (see FIG. 4) of each of the first and second torsion springs 86, 88.

Yet another spring retaining construction includes a retaining pin 102 that extends through an inner diameter of at least one of the first and second springs. In the illustrated embodiment of FIG. 4, the retaining pin 102 has a length L that extends through both of the first and second spring 86, 88 of the spring arrangement 15. In this embodiment, the pin 102 is secured in the position shown by opposing reaction forces F1 and F2 acting against the first pedal lobe 72 and the third base lobe 76.

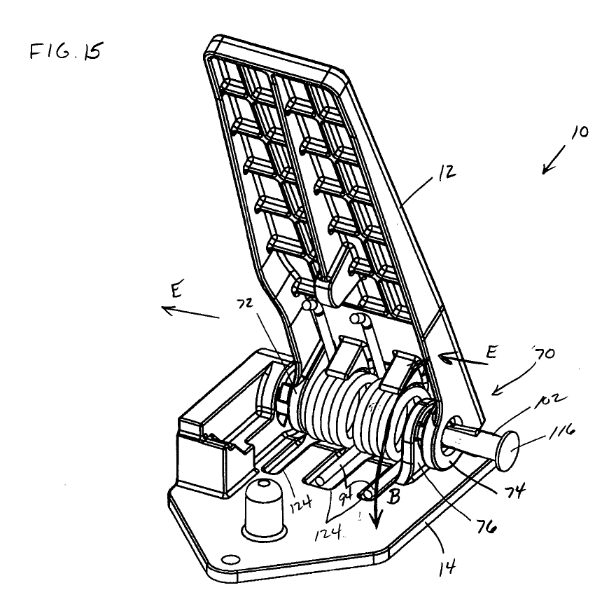

Referring now to FIG. 13, the retaining pin 102 includes a pin body 104 having a first end 106 and a second end 108. Flexible elements 110 are formed on the pin body 104 of the retaining pin 102. The flexible elements 110 are designed to provide a snap-fit connection when inserted through the aperture 80 of the second pedal lobe and an aperture 112 (FIG. 4) of the second bearing structure 33 of the third base lobe 76. In particular, the flexible elements are compressed when the pin is inserted within the aperture 112 and expand outward to act against an inner surface 114 of the third base lobe 76 when completely inserted. Referring back to FIG. 4, when completely inserted, the second end 108 of the retaining pin 102 is received within a recess 142 formed in the first pedal lobe 72 of the pedal 12. By this arrangement, the pedal 12 is axially secured in relation to the base; thereby, the spring arrangement, which is retained by the mounting arrangement of the base and pedal, is also axially secured. The retaining pin 102 shown in FIG. 4 further retains the spring arrangement by the fact that the pin body 104 extends through the inner diameters of the spring coils of each of the springs 86, 88.

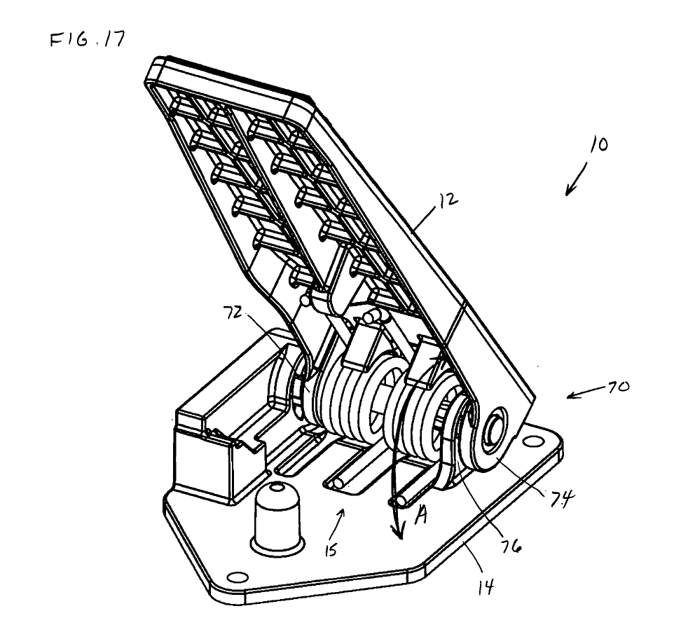

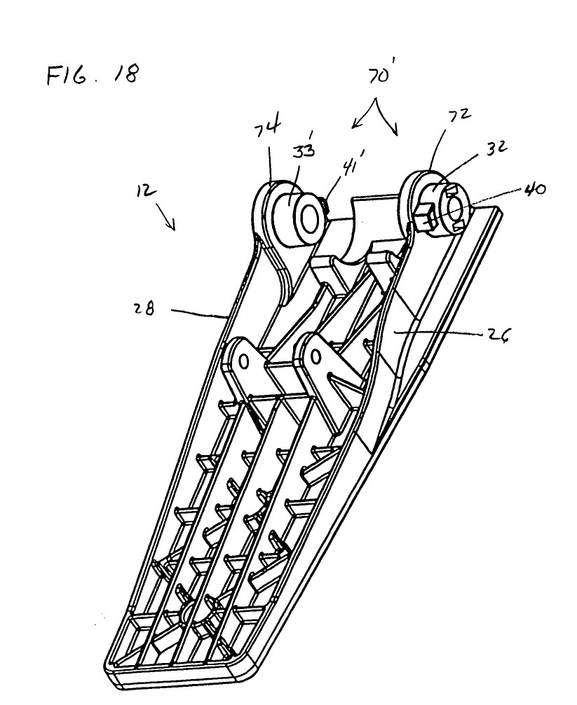

The retaining pin 102 of FIG. 13 includes a head 116 located at the first end 106 of the pin body 104. As can be understood, because each of the reaction forces F1 and F2 (FIG. 4) acts between the retaining pin 102 and the respective mounting lobes 72, 76, the retaining pin 102 need not include the head 116 to function as a retaining device. In the illustrated embodiment, the head 116 is provided and sized to aid in keeping the second bearing structure 33 and aperture 80 free of contaminates. FIGS. 16 and 17, illustrate, however, another embodiment of a retaining pin 122 constructed without a head. With the exception of a head, this retaining pin 122 functions in a manner similar to that of the previous embodiment.

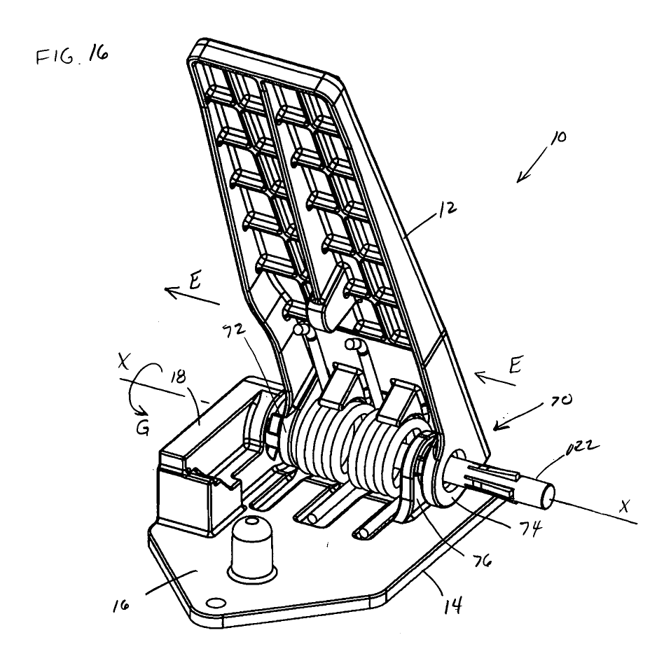

Referring now to FIG. 14, yet another embodiment of a retaining pin 132 is illustrated. In this embodiment, the retaining pin 132 has pin body 134 having a first end 136 and a second end 138. Flexible elements 140 are formed on the pin body 134 of the retaining pin 132. The flexible elements 140 are designed to provide a snap-fit connection when inserted through the aperture 80 of the second pedal lobe and the aperture 112 of the second bearing structure 33. In contrast to the retaining pin 102 of the first embodiment, when the retaining pin 132 is completely inserted within the lobe aperture 112, the second end 138 of the retaining pin 132 does not extend through the inner diameter of both of the springs 86, 88 of the spring arrangement 15. Instead, the retaining pin 132 has a length L′ that extends only partially through one of the first and second spring 86, 88 and retains only the one spring about the inner diameter.

In this embodiment, the pin 132 is secured in the position shown by opposing reaction forces F1′ and F2′ acting against the second pedal lobe 74 and the third base lobe 76. In particular, the retaining pin 132 of FIG. 14 includes a head 146 located at the first end 136 of the pin body 134. The reaction forces F1′ (provided by the head 146) and F2′ (provided by the flexible elements 140) act between the retaining pin 102 and the respective mounting lobes 74, 76 to axially secure the pedal 12 in relation to the base 14. Thereby, the spring arrangement 15, which is retained by the mounting arrangement of the base and pedal, is also axially secured.

In each of the disclosed embodiments, the spring arrangement 15 is retained in relation to the pedal 12 and the base 14 by a number of spring retaining constructions, including a first spring retaining construction that retains the springs about the outer diameter of the spring coils; a second spring retaining construction that retains at least one spring about the inner diameter of the spring coil; and a third spring retaining construction that axially retains the springs of the spring arrangement by sandwiching the springs 86, 88 between lobes 72, 76 of the mounting arrangement 70.

Referring now to FIG. 15, the base 14 of the pedal assembly 10 includes recesses 124. The recesses 124 are sized to receive portions of the springs 86, 88 of the spring arrangement 15. In particular, the recesses 124 are configured to receive the lower tangs 94 of each of the torsion springs 86, 88. The base 14 of FIG. 15 is illustrated with two recesses 124 to receive the lower tangs of each of the first and second torsion springs 86, 88. In the embodiment of FIG. 1, the base 14 includes three recesses 124 to accommodate use of a different spring arrangement. Other numbers of recesses can be used in accord with the principles of the present disclosure.

In use, an operator presses down on the pedal 12, which in turn compresses the torsion springs. The upper tangs 92 of the springs contact the bottom surface 96 of the pedal so that when the pedal 12 is released, the springs bias the pedal back to the first angular position A (FIG. 1). The recesses 124, in addition to the first, second and third spring retaining constructions, also assist in retaining each of the springs 86, 88 of the spring arrangement 15 in position during assembly and operation of the pedal assembly 10.

Further, the recesses 124 aid in providing an assembly that is self-contained. What is meant by self-contained is that the pedal 12 and the base 14 are structurally predisposed or biased to remain assembled during operation. Specifically, the torsion springs 86, 88 are arranged such that the windings of the spring coils act to bias the pedal in the direction E (FIG. 15) when loaded (i.e. the pedal is depressed). In particular, the lower tangs of the springs are contained within and act against the recesses 124 of the base 14, while the upper tangs of the springs act against the pedal 12 in the direction E when the springs are wound or loaded. This arrangement assists in maintaining the pedal 12 in an assembled relationship with the base 14 during operation.

Another feature of the disclosed pedal assembly 10 relates to assembly of the various components. The present electronic pedal assembly 10 is designed to ease the overall pedal assembly procedure. The electronic pedal assembly is assembled by first partially assembling the pedal 12 to the base 14. First partially assembling the pedal 12 includes orienting the pedal 12 relative to the base 14 as shown in FIG. 2 and placing the springs 86, 88 of the spring arrangement 15 within the recesses 124 formed in the base 14.

The bearing structure 32 of the pedal 12 is then axially inserted within the receiving hub 20 of the base 14 in a direction represented by arrow E, as shown in FIGS. 2 and 15. As the pedal 12 is moved in the direction E, the arms 98 of the pedal 12 are positioned about the outer diameters of the springs 86, 88.

Initially, the bearing structure 32 is slid only a first distance within the receiving hub 20. The first distance is limited by interference or contact between the tab 40 positioned on the bearing structure 32 and a stop notch 126 (FIG. 6) formed within the slot 42 of the receiving hub 20. That is, only a portion of the bearing structure 32 is initially positioned within the receiving hub 20. Likewise, the second tab 41 of the second bearing structure 33 functions in the same manner to limit insertion of the second bearing structure 33 within the aperture 80. As can be understood, in the alternative embodiment of FIGS. 18 and 19, the second tab 41′ of the second bearing structure 33′ is positioned with a stop notch 127 of the slot 43 of the second receiving hub 21 during this assembly step. Positioning the tab, e.g. 40, within the stop notch 126 provides an initial, partial interconnection between the pedal 12 and the base 14. The partial interconnection creates a relational stability between the pedal 12 and the base 14 during the remaining steps of the assembly procedure.

When the tab 40 is located within the stop notch 126 of the slot 42, the pedal 12 is rotationally oriented in a non-preloaded position relative to the base 14 such that the spring arrangement 15 is in a non-preloaded state. Specifically, as shown in FIG. 15, the pedal 12 is oriented at an angle B that is greater than the first angular position A shown in FIG. 1 (FIG. 1 illustrated the electronic pedal assembly fully assembled).

With the tab 40 positioned within the stop notch 126, the pedal 12 is then rotated relative to the base 14 about the axis of rotation X-X, as shown in FIG. 16. In particular, the pedal 12 is rotated from the non-preloaded position to an angular position in direction G at which the tab 40 is located beyond the stop notch 126. At this angular position, the tab 40 on the bearing structure 32 of the pedal 12 is aligned for receipt within a deeper primary portion 128 (FIG. 6) of slot 42. The primary portion 128 of the slot 42 is defined between the first and second ends 44, 46 of the slot. Similarly, the second tab 41 of the second bearing structure 33 is aligned with respect to the slot (not shown) of the aperture 80. By rotating the pedal 12 in the direction G beyond the stop notch 126, the springs 86, 88 of the spring arrangement 15 are partially compressed and are preloaded.

Referring to FIGS. 16 and 17, the bearing structure 32 of the pedal 12 is then axially inserted or slid a second distance within the receiving hub 20 in the first direction (arrow E) to a position beyond the first distance. That is, the bearing structure 32 of the pedal 12 is now further slid into the receiving hub 20 so that the tab 40 of the bearing structure 32 is positioned within the primary portion 128 of the slot 42 between the first and second ends 44, 46 of the slot. Likewise, the second tab 41 is positioned with the slot of the aperture 80. The spring arrangement 15 is preloaded only during the second axial positioning, i.e., only when the pedal 12 is slid the second distance.

Once the tabs 40, 41 are positioned within the primary portions of the slots in the receiving hub 20 and the aperture 80, the pedal 12 may be released. The pedal 12 is then biased toward the first angular position A (FIGS. 1 and 17) by the spring arrangement 15. As can be understood, the first angular position A is defined by the location of the first end 44 of the slot 42 and the location of the tab 40. The relative locations of the first end 44 of the slot 42 and the tab 40 function to maintain a spring load on the pedal 12 when the pedal 12 is in an idle position, for example. Accordingly, the idle position of the pedal 12 can be modified by changing the relative locations of the first end 44 of the slot 42 and/or the tab 40.

Still referring to FIGS. 16 and 17, during assembly, the retaining pin 122 (and, in the alternative, pin 102 or 132) is inserted through the pedal aperture 80 and the aperture 112 (FIG. 6) formed in the second bearing structure 33. To complete the assembly, the retaining pin 122 is snapped into position when the tab 40 is positioned with the primary portion 128 of the slot 42 in the receiving hub 20 to secure the pedal 12 in relation to the base 14.

In operation, the pedal 12 is depressed to provide an operational output. The sensor 50 translates the pedal position into an electrical signal, proportional to the pedal angle, for input into an electronic engine controller or to provide feedback to the operator. The base stop 48 limits the rotational angle through which the pedal 12 may be depressed.

The electronic pedal assembly 10 of the present disclosure has a number of safety, operational, and manufacturing features. For example, the second end 46 of the slot 42 in the receiving hub 20 acts as a fail-safe stop in the event the base stop 48 wears or fails to limit pedal rotation. Also, as shown in FIG. 1, the first bearing structure 32 and slot 42 are concealed by the overall arrangement of the pedal and base to protect the first bearing structure 32 from contamination during operation. Likewise, the second bearing structure 33 may be concealed by the head (e.g., 116) of the retaining pin 102 to protect the second bearing structure 33 from contamination. This prevents premature failure or reduced rotational travel, which often occurs in arrangements having exposed bearing components. In addition, the pedal assembly 10 includes a number of spring retaining constructions to ensure proper containment of the spring arrangement 15. Further, as previously described, the overall design (e.g., the integral sensor housing and the tab/slot arrangement) provides an inexpensive and easy-to-assembly unit.

The above specification provides a complete description of the present invention. Since many embodiments of the invention can be made without departing from the spirit and scope of the invention, certain aspects of the invention reside in the claims hereinafter appended.

What is claimed is:

1. A method of assembling a pedal device, the method comprising the steps of:
a) providing a base, a pedal, and at least one spring configured to bias the pedal relative to the base, the base defining a receiving hub configured to receive a bearing structure formed on the pedal;
b) partially assembling the pedal to the base by axially sliding the bearing structure of the pedal within the receiving hub of the base in a first direction;
c) rotating the pedal relative to the base to preload the spring; and
d) fully assembling the pedal to the base by further axially sliding the bearing structure within the receiving hub in the first direction.

2. The method of claim 1, wherein the step of partially assembling the pedal includes axially sliding the bearing structure within the receiving hub a first distance, the first distance being limited by contact between a tab positioned on the bearing structure and the base.

3. The method of claim 2, wherein the step of rotating the pedal relative to the base includes rotating the pedal relative to the base such that the tab is aligned with a slot formed in the receiving hub.

4. The method of claim 3, wherein the step of fully assembling the pedal to the base includes further axially sliding the bearing structure within the receiving hub such that the tab is positioned within the slot of the receiving hub.

5. The method of claim 1, wherein the step of partially assembling the pedal to the base includes positioning the pedal relative to the base such that the spring is in a non-preloaded state.

6. The method of claim 5, wherein the step of fully assembling the pedal to the base includes further axially sliding the bearing structure within the receiving hub while the spring is preloaded.

7. A pedal assembly, comprising:
a) a base including a platform and a receiving hub, the receiving hub having a slot;
b) a pedal pivotally mounted to the base, the pedal including a bearing structure positioned within the receiving hub, the bearing structure having a cylindrical bearing surface and a tab projecting radially from the cylindrical bearing surface, the tab being positioned within the slot of the receiving hub; and
c) at least one spring arranged to bias the pedal to a first angular position relative to the base.

8. The pedal assembly of claim 7, further including a sensor arranged to sense a position of the pedal relative to the base.

9. The pedal assembly of claim 8, wherein the base further defines a housing structure, the sensor being located within the housing structure.

10. The pedal assembly of claim 9, wherein the receiving hub is formed within the housing structure of the base.

11. The pedal assembly of claim 7, wherein the tab of the bearing structure is located a distance from an edge of the bearing structure.

12. The pedal assembly of claim 7, wherein the tab is arranged to contact a first end of the slot to limit the angular rotation of the pedal relative to the base.

13. The pedal assembly of claim 7, wherein the spring is a torsion spring having a spring coil and tangs extending outward from the spring coil.

14. The pedal assembly of claim 13, wherein the base includes recesses configured to receive the tangs of the torsion spring.

15. The pedal assembly of claim 14, wherein the pedal include spring retaining structure configured to retain the spring coil of the torsion spring.

16. The pedal assembly of claim 7, wherein the pedal includes spring retaining structure configured to retain the spring about an outer diameter of the spring.

17. The pedal assembly of claim 16, wherein the spring retaining structure includes curved arms arranged to curve about the outer diameter of the spring.

18. The pedal assembly of claim 7, further including a spring retaining structure configured to retain the spring about an inner diameter of the spring.

19. The pedal assembly of claim 18, wherein the spring retaining structure includes a retaining pin.

20. The pedal assembly of claim 7, wherein the spring is retained between first and second lobes, the first lobe being interconnected to the pedal, the second lobe being interconnected to the base.

21. A pedal assembly, comprising:
a) a base and a pedal, the pedal being pivotally mounted to the base by a mounting arrangement, the mounting arrangement including first and second lobes located a distance from one another, one of the lobes being connected to the base and the other of the lobes being connected to the pedal;
c) a spring arrangement arranged to bias the pedal to a first angular position relative to the base, the spring arrangement being positioned between the first and second lobes of the mounting arrangement, the spring arrangement having a width;
d) wherein the width of the spring arrangement substantially corresponds to the distance between the first and second lobes to axially maintain the pedal in relation to the base.

22. A pedal assembly, comprising:
a) a base and a pedal, the pedal being pivotally mounted to the base;
b) a spring arranged to bias the pedal to a first angular position relative to the base, and
c) a first spring retaining construction configured to retain the spring in relation to the pedal and base, the first spring retaining construction including arms extending from a bottom surface of the pedal, the arms including curved surfaces that extend about an outer diameter of the spring.

23. The spring arrangement of claim 22, further including a second spring retaining construction, the second spring retaining structure including a pin that extends through an inner diameter of the spring to retain the spring in relation to the pedal and base.

24. The spring arrangement of claim 23, further including a third spring retaining construction, the third spring retaining construction including first and second lobes positioned adjacent to opposite ends of the spring to retain the spring in relation to the pedal and base.

25. A method of manufacturing a base for use with an electronic pedal assembly, the method comprising the steps of:
a) providing a base having an integral sensor housing, the integral sensor housing defining an interior region;
b) providing a divider structure having a first edge, the first edge defining a number of slots;
c) placing electronic components within the interior region of the housing;
d) selectively orienting the divider structure within the interior region of the housing in one of:
i) a first orientation to provide a first number of wire exits for the electronic components; and
ii) a second orientation to provide a second number of wire exits for the electronic components, the second number of wire exits being different that the first number of wire exits.

26. A pedal assembly, comprising:
a) a base including a platform and an integral sensor housing, the sensor housing defining a receiving hub having a slot, the slot having first and second ends, the base further including a recess formed in the platform;
b) a pedal pivotally mounted to the base, the pedal including a pedal surface extending between first and second flanges, at least one of the first and second flanges including a bearing structure projecting outward from the flange, the bearing structure being positionable within the receiving hub, the bearing structure including a tab, wherein the tab is arranged to contact at least one of the ends of the slot of the receiving hub to limit rotation of the pedal relative to the base;
c) at least one spring having an inner diameter and an outer diameter, the spring being at least partially located in the recess formed in the platform, the spring being retained in position relative to the base and pedal by a retaining construction, the retaining construction being arranged to extend about the outer diameter of the torsion spring; and
d) a retaining pin positioned to secure the pedal in relation to the base, the retaining pin having a pin body that extends through the inner diameter of the spring.
